(19) United States
(12) Patent Application Publication
(10) Pub. No.: US 2022/0036445 A1
(43) Pub. Date: Feb. 3, 2022

(54) SYSTEM AND METHOD FOR PROVIDING PEST CONTROL SERVICES

(71) Applicant: Insects Limited, Inc., Westfield, IN (US)

(72) Inventor: Thomas Mueller, Westfield, IN (US)

(73) Assignee: Insects Limited, Inc., Westfield, IN (US)

(21) Appl. No.: 17/366,393

(22) Filed: Jul. 2, 2021

Related U.S. Application Data
(60) Provisional application No. 63/059,414, filed on Jul. 31, 2020.

(51) Int. Cl. G06Q 30/08; A01M 1/02; A01M 1/14; G06Q 10/10

(52) U.S. Cl. CPC G06Q 30/08; G06Q 10/1053; A01M 1/14; A01M 1/026

(57) ABSTRACT

A method of providing pest control service to a customer includes signing up the customer for a pest monitoring service. A pest sensor or multiple pest sensors are set up to monitor a pest monitoring site designated by the customer. The pest sensor determines that there is a need for pest control service within the pest monitoring site. A pest control technician and the customer are alerted that pest control services are needed at the pest monitoring site without additional intervention by the customer. The pest control technician and the customer to make an appointment for the technician to provide pest control service, and the pest control technician provides the necessary pest control service at the pest monitoring site.

### CROSS REFERENCE TO RELATED APPLICATIONS

The present patent document claims the benefit of the filing date of Provisional U.S. Patent Application No. 63/059,414, filed on Jul. 31, 2020, which is hereby incorporated by reference in its entirety.

### BACKGROUND

Pest control is a billion dollar industry and an important service for customers who have pest infestation problems. Proper pest control can help prevent structural damages to buildings, damage to plants and agricultural products, and promotes proper sanitation. For some customers, constant monitoring for pests may be necessary to prevent possible pest related issues. In general, it is up to the customer to contact a pest control technician when there is a pest infestation. However, at times, it may be difficult for a customer to determine when there is a significant pest problem that may present issues. Therefore, there is a need for improvement in this field.

### SUMMARY

Certain embodiments include a method of providing pest control service to a customer. In one form, the method includes determining a need for pest control service at a pest monitoring site based on data generated by one or more pest sensors. A pest control technician is alerted that pest control service is needed. In some embodiments, the determination that pest control service is needed and the process of alerting the pest control technician is completed without intervention by the customer. The alert is automatically generated upon determining a need for pest control service based on the data generated by the one or more pest sensors. The customer is then notified of the need for pest control service and appointment is created for the pest control technician to provide pest control service at the pest monitoring site.

In some embodiments, the method of providing pest control service further includes performing the pest control service at the pest monitoring site. The method may also include signing up the customer for pest control service before installing the pest sensors at the pest monitoring site.

In one form, the pest sensor is a pheromone sensor for detecting the presence of insects. The pheromone sensor includes a glue board for trapping insects attracted to the pheromone sensor and the data generated by the pheromone sensor is an image of a glue board. The image of the glue board may be analyzed by computer software to determine whether there is a need for pest control service.

In another form, the method of providing pest control service to a customer includes monitoring a pest monitoring site using one or more pest sensors and determining a need for pest control service at a pest monitoring site based on data generated by the one or more pest sensors.

A pest control job is created in a pest control portal, which in some aspects is a mobile application. The nature of the pest control job is determined by data generated by the one or more pest sensors without intervention by the customer. Registered pest control technicians are allowed to bid on the pest control job by indicating the price for which they will provide the necessary pest control service. An appointment is created for the pest control technician that wins the bid for the pest control job to provide pest control service at the pest monitoring site. In some embodiments, the pest control technician that wins the bid for the pest control job is the pest control technician that bids the lowest price. In other embodiments, the pest control technician who wins the bid is chosen by the customer.

In some embodiments, the customer is notified of the need for pest control service after a pest sensor determines there is a need for pest control. Additionally, the registered pest control technicians may be notified when there is a new pest control job available for bidding.

In some embodiments, data generated by said one or more pest sensors is transmitted to a remote computing device. As an example, this data may be data regarding the presence of insects that is collected using a pheromone sensor or a pheromone trap.

Certain embodiments may also include a pest control service system that includes a pest sensor. The pest sensor is configured to generate pest data related to pests in a pest monitoring site. The system also includes a remote computing device including a pest control portal. The remote computing device is in electronic communication with the pest sensor, and the remote computing device is configured to receive pest data from the pest sensor.

A pest control job is created in the pest control portal when pest data generated by the pest sensor indicates that there is a pest infestation in the pest monitoring site. The remote computer device is electronically accessible by a personal computing device, and the pest control job is viewable by said personal computing device.

In some embodiments, the pest control portal is configured to allow said one or more pest control technicians to bid to provide pest control service for said pest control job. In one aspect, The pest control job is awarded to the pest control technician who submits the bid with the lowest price to provide pest control service for said pest control job.

In some embodiments, the pest control job is created automatically without intervention by a customer. Additionally, the pest control portal may be accessible as a mobile application

In some forms, the pest sensor is a pheromone trap for detecting the presence of insects using a glue board. A pheromone lure may be included in the pheromone trap to attract insects.

### BRIEF DESCRIPTION OF THE DRAWINGS

FIG. 1 is a schematic diagram of a pest control service system.

FIG. 2 is a diagram of pest sensors of the pest control service system of FIG. 1 installed in a pest monitoring site.

FIG. 3 is a perspective view of a pheromone monitor for use with the pest control service system of FIG. 1.

FIG. 4 is a perspective view of a pheromone trap including a glue board for use with the pest control service system of FIG. 1.

FIG. 5 is a flow chart illustrating a method of providing pest control services.

FIG. 6 is a flow chart illustrating an alternative embodiment of a method of providing pest control services.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

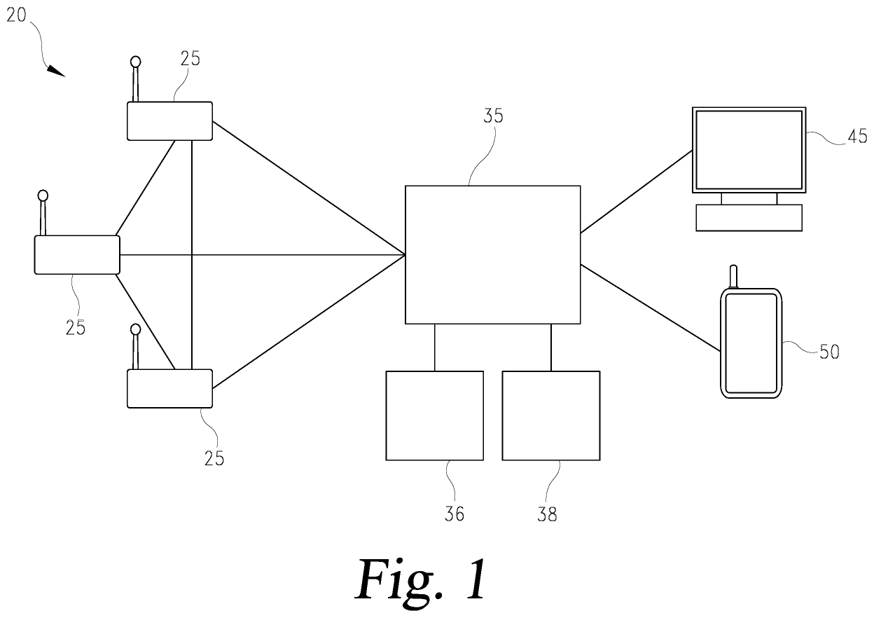

FIG. 1 illustrates a schematic diagram showing a pest control service system 20. The pest control service system 20 includes one or more pest sensors 25. Although three pest sensors 25 are shown in FIG. 1, in other embodiments, the pest control service system 20 may contain more or fewer pest sensors 25 as desired. For example, the pest control service system 20 may include one pest sensor 25, two pest sensors 25, or five or ten pest sensors 25. The pest sensor may be any suitable type of sensor for determining when there is a pest infestation. As one representative example, the pest sensor may be a pheromone sensor or a system of multiple pheromone sensors for detecting insects or the pest sensor may be integral with or attached to a glue board for trapping insects. In another example, the pest sensor may be integral with or attached to a trapping device such as a mouse trap, a rat cage, or other wildlife trapping device.

In some embodiments, the pest sensors 25 are also capable of communicating with one or more of the other pest sensors 25. Communication between the pest sensors 25 allows coordination between the pest sensors 25 to assist with determining the extent of a possible pest infestation location or other potential pest issues.

Each of the pest sensors 25 is capable of communicating with a remote computing device 35 to send data, images, or any other necessary information regarding pest activity detected by the pest sensor 25. As used here, the remote computing device 35 generally refers to a computing device that is located in a separate location from other devices it may be in communication via any suitable communication link such as a wireless or wired network. As an example, the remote computing device 35 may be a server, or a database, a cloud based service, a mobile phone or any other suitable form of computing device. The remote computing device 35 includes a data repository 38 that is capable of storing data received from the pest sensors 25. The data repository may be a database, a data store, or another suitable data storage medium.

A pest control portal 36 is included either as a part of the remote computing device 35 or separate from the remote computing device 35 but capable of communication with the remote computing device 35. The pest control portal 36 includes software for managing the pest control service system 20. Customers and pest control technicians may register with the pest control portal 36. The pest control portal 36 may offer a user interface to allow interaction with registered customers and with registered technicians. The pest control portal 36 is also able to create and/or store active pest control jobs that are viewable by registered technicians. The pest control jobs include information regarding the location for needed pest control service and a specification for the type of pest control service that is needed.

The remote computing device 35 is capable of communicating with personal computing devices such as a personal computer 45 or a mobile phone 50 that are owned by customers or by pest control technicians. Communication between the personal computing devices and the remote computing device 35 may be through a wired connection or a wireless connection. Communication with the remote computing device 35 allows a customer and/or a pest control technician to access the pest control portal 36. The customer may view the status of pending pest control jobs or may use the pest control portal 36 to search for and contact pest control technicians. The pest control technicians may use the pest control portal to view available pest control jobs and to receive information on the specification of a job that the pest control technician is scheduled to perform.

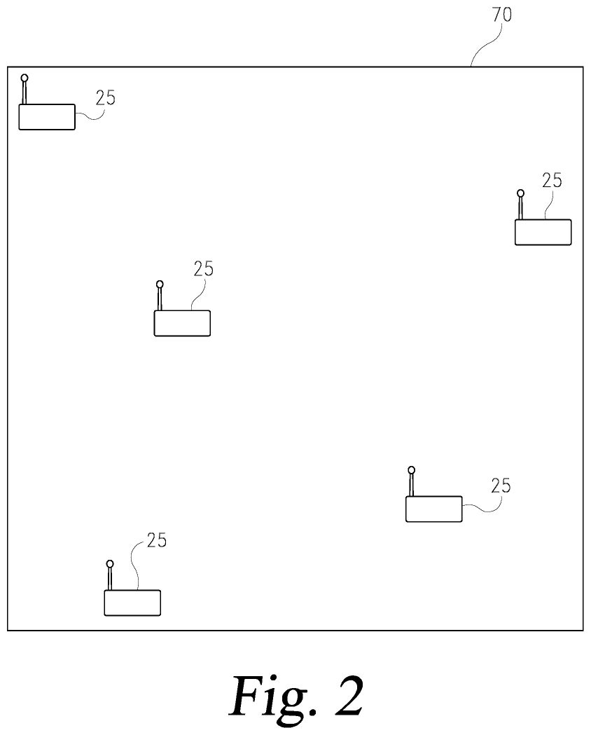

FIG. 2 shows a representative diagram illustrating the use of pest sensors 25 at a pest monitoring site 70. The pest monitoring site 70 may be a residential building, a commercial building, an agricultural field, or any other type of structure or property in which pest monitoring is desired. As shown, the pest monitoring site 70 is designated and one or more pest sensors 25 are distributed throughout the pest monitoring site 70. The pest sensors 25 may be spaced evenly throughout the pest monitoring site 70 or may be placed in locations that are determined to be most likely to have pest control issues. Any number of pest sensors 25 may be introduced to the pest monitoring site 70 as needed to effectively monitor pest activity in the pest monitoring site 70.

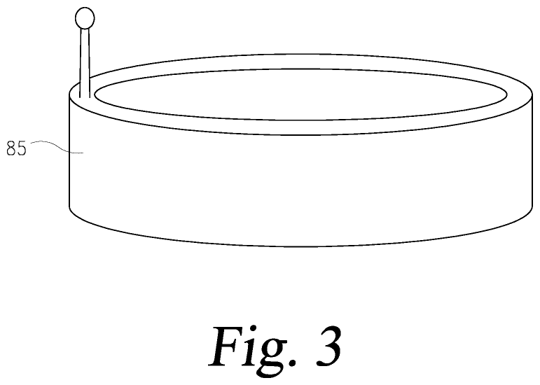

In a representative embodiment, the pest sensor 25 is a remote pheromone monitor 85, shown in FIG. 3. The remote pheromone monitor 85 is installed in the pest monitoring site 70 at a desired location and can determine the pheromone levels, therefore detecting the presence of insects, in the area surrounding the remote pheromone monitor 85. In some embodiments, the pheromone data is transmitted to the remote computing device 35 and pest analysis software stored on the remote computing device 35 is used to analyze the transmitted data and to determine when there is a pest infestation and/or need for pest control service. In other embodiments, the data is processed and analyzed by software that is incorporated into the pheromone monitor 85 and the results of the analysis are later sent to the remote computing device 35 and to the pest control portal 36 to alert the pest control portal 36 of the need to create a pest control job.

In some embodiments, multiple pheromone monitors 85 may be set up in the pest monitoring site 70. The data collected by the pheromone monitors 85 may be transmitted to the remote computing device 35 and this data may be analyzed by pest analysis software. The pest analysis software can map the number of insects in certain locations in the pest monitoring site. The pheromone monitors 85 may also include temperature and humidity gauges to monitor environmental factors that may affect the location or the number of pests that are measured by the pheromone monitors 85.

The data transmitted by pheromone monitors may be used to determine when there is a pest infestation and when pest control service is needed. In one example, there may be a predetermined, threshold pheromone level and when the pheromone monitors measure a pheromone level above the threshold level, a pest control job is automatically created in the pest control portal 36. The pest control job is created without intervention by the customer, so the customer does not have to make a decision on whether pest control service is needed. This greatly reduces the risk that a customer will wait too long to schedule pest control service and could result in the avoidance or limitation of potential damage at the pest monitoring site caused by pests.

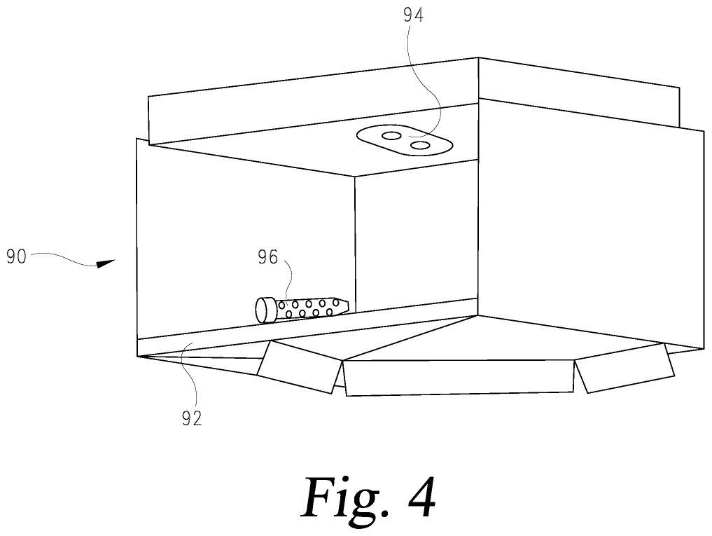

In another representative embodiment, shown in FIG. 4, the pest sensor is a pheromone trap 90 that includes a glue board 92, such as a SightTrap™ remote pheromone monitor sold by Insects Limited®. The pheromone trap includes a pheromone lure 96 that attracts insects to the glue board 92. The pheromone trap 90 also includes a camera 94 or another visual device that produces an image of the glue board 92. In some embodiments, the image of the glue board 92 is transmitted to the remote computing device 35 or to another computer or processing unit that includes pest analysis software that is capable of analyzing the image of the glue board and determining if there is a pest infestation problem from the image of the glue board. In other embodiments, the pest analysis software is incorporated into the pheromone trap 90 and analysis is performed at the pheromone trap 90 rather than at the remote computing device. The processed data may be sent to the remote computing device 35 for storage or other action after analysis has been performed by the pest analysis software at the pheromone trap 90.

In some examples, the pest analysis software is capable of determining the number of pests included in the image of the glue board 92. The software may also be capable of determining the types of pests that have been trapped on the glue board by analysis of the transmitted image. In some embodiments, a pest infestation may be determined at a predetermined threshold for the number of pests trapped on the glue board 92 and/or may be determined based on the types of pests that are found on the glue board 92.

In some embodiments, the camera may take a daily image of the glue board 92 of pheromone trap 90. This image may be taken automatically without requiring any input from a user. The pheromone trap 90 may be monitored remotely by a personal computer, a mobile device, or any other suitable computing device. The images and accompanying analysis may be reviewed on a web-based platform, a mobile application, or any other suitable method of information delivery. The user may view insects caught on glue board 92 that have been identified by the pest analysis software and may be presented data regarding the types and number of insects caught by pheromone trap 90. Additionally, the pheromone trap 90 may provide environmental analysis or data that may affect the insect data that is collected at pheromone trap 90.

If there are multiple pest traps in the pest monitoring site 70, each pheromone trap 90 may transmit an image of their respective glue boards to the remote computing device 35. Pest analysis software may then be utilized to analyze the pest data from these multiple locations in the pest monitoring site. The software analyzes the photos transmitted by each of the pheromone traps 90 and can use these photos to determine if there is a pest infestation and where that pest infestation is in the pest monitoring site 70.

If it is determined that there is a pest infestation, a pest control job is automatically created in the pest control portal 36 without the need for input or intervention by the customer. The customer is not required to call or contact the provider of the pest control provider that provides the pest control service to set up a pest control job. Therefore, the customer does not have to make a determination on when and whether pest control service is needed, as this is determined by analysis of the pest data provided by the pest sensors.

Although the above examples are both directed to the detection of insects, these are merely representative examples, and the pest control service system may be used with many other types of pest sensors 25 and for other kinds of pests. In another example, the pest sensor 25 may be a mousetrap or a network of mousetraps. The mousetraps may be capable of transmitting data to the remote computing device 35 where the data can be analyzed by pest analysis software included on the remote computing device. The need for a new pest control job may be communicated to the pest control portal 36 when the data sent to the remote computing device 35 indicates that there is a pest control issue. The pest control issue may be determined by a predetermined number of mousetraps indicating that a pest has been trapped, or it may be determined that there is a pest control issue when a single mousetrap indicates that it has been tripped a predetermined number of times over a given period of time.

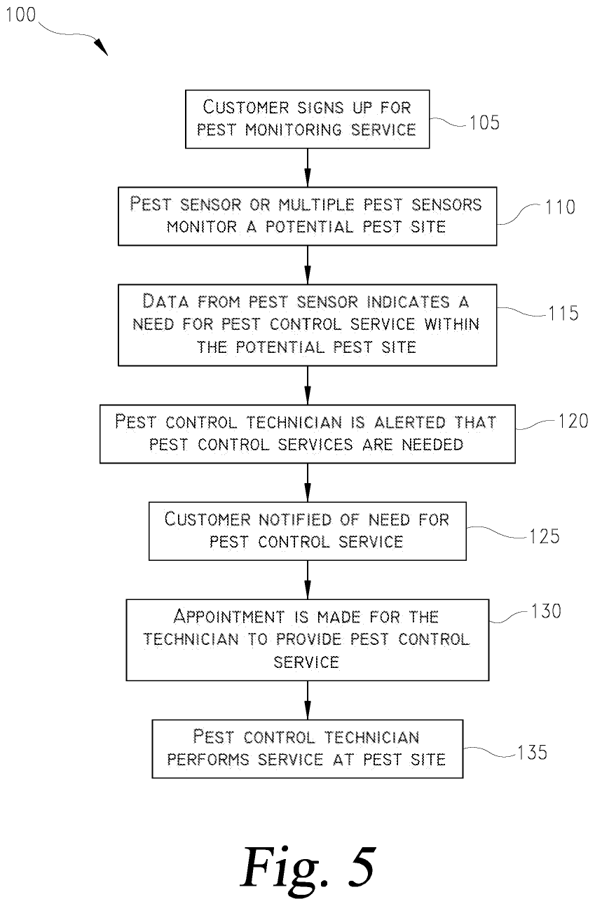

FIG. 5 shows a flow chart 100 illustrating a method of providing pest control services on an as-needed basis through a service provided by a pest control company and/or pest control technician.

In a first stage 105, a customer needing pest control monitoring signs up for a pest control monitoring service. The pest control monitoring service provides as-needed pest control for a predetermined price that is set upon sign up, but that may be later modified upon renegotiation of the terms of the subscription service as necessary. The type of pest or pests that are monitored by the pest control monitoring service may vary depending on the needs of the customer. As an example, the pest control monitoring service may monitor for insects such as ants, termites, spiders, or wasps. In other embodiments, the pest control monitoring service may monitor for pests such as rats, mice, or other undesired animals.

After sign up, in a second stage 110, a pest sensor or multiple pest sensors are set up to monitor a pest monitoring site such as a potential pest site. The pest monitoring site may be any area that could be potentially infested with pests. As an example, the pest monitoring site may be a residential or commercial building or an exterior area of a residential or commercial lot. In other examples, the pest monitoring site may be agricultural structures or land such as a barn or a field.

The pest sensor may be any suitable type of sensor for determining when there is a pest infestation in the pest monitoring site. As one representative example, the pest sensor may be a pheromone sensor or a system of multiple pheromone sensors for detecting insects or the pest sensor may be integral with or attached to a glue board for trapping insects. In another example, the pest sensor may be integral with or attached to a trapping device such as a mouse trap, a rat cage, or other wildlife trapping device.

In a third stage 115, the data from the pest sensor or pest sensors indicate that there is a need for pest control service within the pest monitoring site or potential pest site. This determination may be made using any suitable method for determining that there is a pest infestation or that there is a high probability of a pest infestation. In one embodiment, the pest sensor may be a pheromone monitor that takes an image of a pheromone trap glue board and sends the image data to a central processing unit that is able to analyze the image and determine when there is a possible infestation issue. If enough insects are detected in the trap, the sensor will determine that there is a need for pest control service. In another embodiment, the pest sensor may be a mousetrap and when the sensor detects that a mouse has been caught in the trap, the sensor determines that pest control service is needed.

In some embodiments, the determination of the need for pest control service may be accomplished by the use of software that is incorporated into the pest sensor. In other embodiments, data is transmitted from the pest sensor to a remote computing device that includes software that is capable of analyzing the data from the pest sensor and determining when pest control service is needed.

In a fourth stage 120, a pest control technician is alerted that pest control services are needed at the pest monitoring site. The pest control technician may be an employee of the company or business entity that provides the pest control monitoring service, or the pest control technician may be a third party that is hired by the pest control monitoring service to provide pest control as part of the pest control monitoring plan. In some embodiments, the alert is sent to the pest control technician electronically, directly from the pest sensor or from a central processing unit to which the pest sensor is electrically connected. The electronic communication of the alert can be made using any suitable communication means, such as over a wireless network or a wired network. The pest control technician may be alerted that pest control services are needed without any input from the customer. The pest sensor does not require any additional input from the customer to determine when pest control is necessary.

In an optional fifth stage 125, the customer is notified that they are in need of pest control service. The customer may be informed of the need for pest control service by any effective notification method. In one example, a pest sensor may give an audio or visual notification to the customer of the need for pest control service. In another embodiment, the customer may be notified directly by the pest control technician after the pest control technician is alerted that pest control services are needed. The timing for notifying the customer may also vary in different embodiments. In some embodiments, the customer is notified by the pest sensor that pest control service is needed at the same time as or immediately after the pest sensor determines there is a need for pest control service. In other embodiments, the customer may not be notified until after an alert has been sent to the pest control technician.

In a sixth stage 130, an appointment is made for the pest control technician to provide pest control service at the pest monitoring site. The appointment may include a date and a time for the pest control service. In some embodiments, the pest control technician may suggest a date and time for pest control service at the time of notification to the customer of the need for pest control service. In other embodiments, the pest control technician and the customer discuss an appropriate appointment time after the customer is notified of the need for pest control service. In still other embodiments, the appointment is automatically generated by scheduling software (e.g., Acuity Scheduling at acuityscheduling.com).

In a seventh stage 135, the pest control technician performs the pest control service at the pest site. The pest control technician may take any actions necessary to resolve the pest infestation at the pest monitoring site. Also, in some embodiments, the pest control technician may reset the pest sensor so that the pest sensor can provide continuing monitoring of the pest monitoring site.

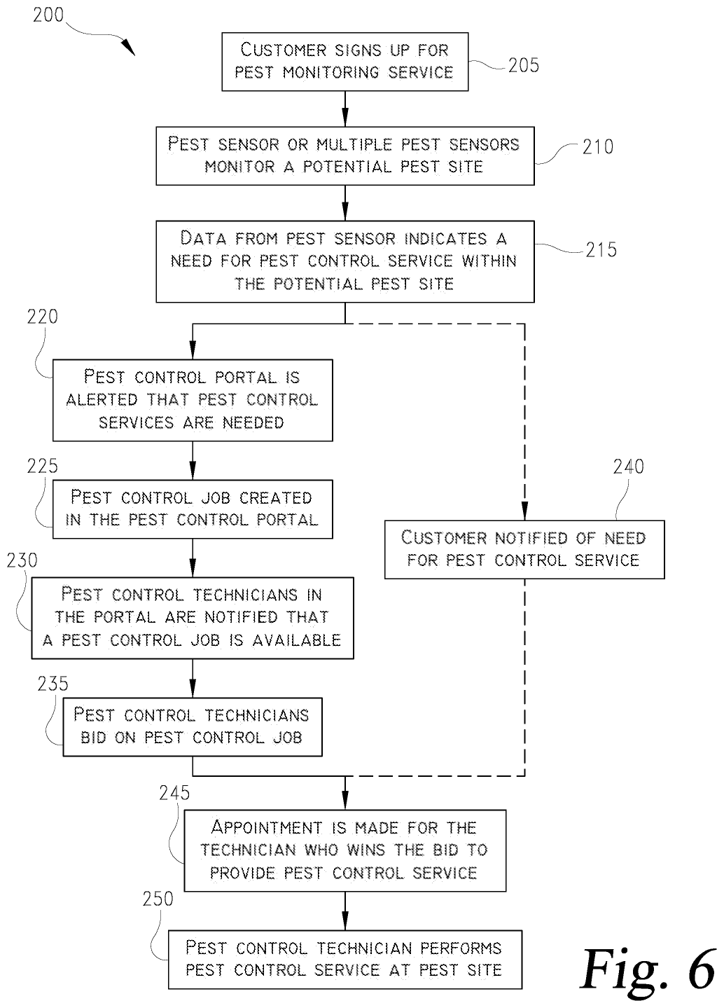

FIG. 6 shows a flow chart 200 illustrating an alternative method of providing pest control services on an as-needed basis through a service provided by a pest control company and/or pest control technician.

The initial stages 205, 210, 215 of flow chart 200 are the same as the corresponding stages described in flow chart 100 described above. In a first stage 205, a customer needing pest control monitoring signs up for a pest control monitoring service. The pest control monitoring service provides as-needed pest control for a predetermined price that is set upon sign up, but that may be later modified upon renegotiation of the terms of the subscription service as necessary. After sign up, in a second stage 210, a pest sensor or multiple pest sensors are set up to monitor a pest monitoring site, such as a potential site. In a third stage 215, data from the pest sensor indicates that there is a need for pest control service within the potential pest site.

In a fourth stage 220, an alert is sent to a remote computing device that includes a pest control portal that pest control services are needed. The remote computing device may be a server, a mobile phone, a cloud-based structure, a network, or any other suitable computing device. The pest control portal may be a mobile application, a database, a website, or any other suitable electronic system that is capable of storing and/or displaying information regarding open or pending pest control jobs. The alert includes information regarding the required pest control services, the location where the pest control services are needed, and any other pertinent information regarding the pest control services that may be necessary. The alert may be generated by the pest sensor and sent to the pest control portal by a wired connection or by a wireless connection.

In a fifth stage 225, a pest control job is created in the pest control portal based on the information that is provided to the pest control portal by the sensor in the fourth stage 220. The specification for the pest control job are viewable by pest control technicians that are logged into the pest control portal. The pest control portal may limit the pest control job so that it is viewable only by pest control technicians who are located near the site of the pest control job. This may be accomplished by creating a distance limit on viewable pest control job for registered pest control technicians, so that the pest control portal doesn't overwhelm the registered pest control technicians with jobs that are outside of their desired distance range. The pest control technicians may further customize the pest control jobs viewable to them in the pest control portal by other job attributes such as the type of pest or type of service to be rendered.

In an optional sixth stage 230, pest control technicians are notified or alerted that a new pest control job is available. In some embodiments, the pest control technicians who are alerted of the new pest control job are registered in the pest control portal The notification may be audio or visual, and may take any suitable form of alerting the pest control technician such as a push alert, an email, or a text message. A pest control technician may customize their alerts so that alerts are only received for certain types of pest control jobs, such as jobs within a certain distance from the technician or jobs for specific types of pests.

In a seventh stage 235, pest control technicians who are interested in providing the pest control service for the pest control job place bids for the price it would cost for them to complete the pest control job. In one exemplary embodiment, the bid process is automatically controlled and winning bid awarded via an in-house online bid submission process using custom made or purchased auction software (e.g., auctionsoftware.com) or a third party online bidding platform (Bidpath, etc.).

In an optional eighth stage 240, the customer paying for the pest control service is notified of the need for pest control service. The customer is notified by the pest sensor, by the pest control portal, or by some other suitable method of notification. The order in which the eighth stage 240 is performed may change in different embodiments and may be before or after any of the stages 215, 220, 225, 230, or 235. In some embodiments, the customer is notified of the need for pest control service at the same time as or nearly the same time as the pest control portal is alerted that pest control services are needed in the third stage 215. In other embodiments, the customer is notified after the pest control job is created in the pest control portal or after pest control technicians have bid on the pest control job.

In a ninth stage 245, the pest control technician who wins the bid is connected with the customer to set up an appointment for the required pest control service. The pest control technician who wins the bid may be chosen by one of several different methods. In some embodiments, the technician who is rewarded the job may be automatically chosen by the pest control portal as the technician who has bid the lowest price to perform the pest control job. In other embodiments, the customer may view each of the bids submitted technicians and choose the bid that they would like to accept. In this embodiment, the customer is not obligated to choose the pest control technician who submits the lowest bid.

The method of contact between the selected pest control technician and the customer may also vary in different embodiments. In some instances, the pest control technician may contact the customer through the pest control portal. In other embodiments, the pest control technician may contact the customer by telephone, email, or text message.

In a tenth stage 250, the pest control technician performs the pest control service at the pest site. The pest control technician may take any actions necessary to resolve the pest infestation at the pest monitoring site. Also, in some embodiments, the pest control technician may reset the pest sensor so that the pest sensor can provide continuing monitoring of the pest monitoring site.

The flow charts described above are representative examples of different embodiments of methods of providing pest control services. In other embodiments, the order of the stages may be rearranged or modified. Additionally, in other embodiments, some of the stages may be considered optional and skipped or not performed.

The entity providing the pest control service generates revenue from the initial sale of the pest sensors as well as from the continued cost of the monitoring service using those pest sensors. Additional revenue may be generated by providing pest control service or from a fee taken from the pest control technician who wins the bid to provide pest control service to the customer.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method of providing automated pest control service to a customer comprising:
monitoring a pest monitoring site using one or more pheromone traps configured to detect the presence of insects, wherein each of said one or more pheromone traps includes a glue board, a pheromone lure, and a visual device for producing an image of the glue board;
transmitting data generated by said one or more pheromone traps to a remote computing device including a pest control portal, wherein said remote computing device is in electronic communication with said one or more pheromone traps, and wherein said remote computing device is electronically accessible by a personal computing device;
determining a need for pest control service at a pest monitoring site based on the data generated by said one or more pheromone traps without intervention by the customer;
notifying the customer of the need for pest control service;
creating a pest control job in the pest control portal, wherein the nature of the pest control job is determined by data generated by the one or more pheromone traps, and wherein the pest control job is created automatically upon the determining a need for pest control service based on the data generated by the one or more pheromone traps;
online auctioning the pest control job by allowing registered pest control technicians to bid on the pest control job by submitting a price for which they will provide the necessary pest control service; and
automatically scheduling a customer service appointment for the pest control technician that wins the bid for the pest control job to provide pest control service at the pest monitoring site, wherein the pest control technician that wins the bid for the pest control job is chosen by the customer.

2. A method of providing pest control service to a customer comprising:
determining a need for pest control service at a pest monitoring site based on data generated by one or more pest sensors;
alerting a pest control technician that pest control service is needed, wherein the alert is automatically generated upon determining a need for pest control service based on the data generated by the one or more pest sensors;
notifying the customer of the need for pest control service; and
creating an appointment for the pest control technician to provide pest control service at the pest monitoring site.

3. The method of claim 2, further comprising:
performing the pest control service at the pest monitoring site.

4. The method of claim 2, wherein data generated by said one or more pest sensors is transmitted to a remote computing device.

5. The method of claim 2, wherein the determination that pest control service is needed is made without intervention by the customer.

6. The method of claim 2, wherein the pest sensor is a pheromone trap configured to detect the presence of insects.

7. A method of providing pest control service to a customer comprising:
monitoring a pest monitoring site using one or more pest sensors;
determining a need for pest control service at a pest monitoring site based on data generated by the one or more pest sensors;
creating a pest control job in a pest control portal, wherein the nature of the pest control job is determined by data generated by the one or more pest sensors, and wherein the pest control job is created without intervention by the customer;
allowing registered pest control technicians to bid on the pest control job by indicating a price for which they will provide the necessary pest control service; and
creating an appointment for the pest control technician that wins the bid for the pest control job to provide pest control service at the pest monitoring site.

8. The method of claim 7, further comprising:
notifying the customer of the need for pest control service.

9. The method of claim 7, further comprising:
notifying pest control technicians registered in the pest control portal that the pest control job is available.

10. The method of claim 7, wherein the pest control portal is a mobile application.

11. The method of claim 7, wherein the pest control technician that wins the bid for the pest control job is the pest control technician that bids the lowest price.

12. The method of claim 7, wherein the pest control technician that wins the bid for the pest control job is chosen by the customer.

13. The method of claim 7, wherein data generated by said one or more pest sensors is transmitted to a remote computing device.

14. The method of claim 7, wherein the pest sensor is a pheromone sensor configured to detect the presence of insects.

15. A pest control service system comprising:
a pest sensor, wherein said pest sensor is configured to generate pest data related to pests in a pest monitoring site;
a remote computing device including a pest control portal, wherein said remote computing device is in electronic communication with said pest sensor, and wherein said remote computing device is configured to receive pest data from said pest sensor;
wherein a pest control job is created in said pest control portal when pest data generated by said pest sensor indicates that there is a pest infestation in said pest monitoring site; and
wherein the remote computer device is electronically accessible by a personal computing device, and wherein said pest control job is viewable by said personal computing device.

16. The pest control service system of claim 15, wherein said pest control portal is configured to allow one or more pest control technicians to bid to provide pest control service for said pest control job.

17. The pest control service system of claim 15, wherein said pest control job is awarded to a pest control technician who submits a bid with the lowest price to provide pest control service for said pest control job.

18. The pest control service system of claim 15, wherein said pest control portal is accessible by a mobile application.

19. The pest control service system of claim 15, wherein the pest control job is created automatically without intervention from a customer.

20. The pest control service system of claim 15, wherein the pest sensor is a pheromone trap configured to detect the presence of insects using a glue board.
